(19) United States
(12) Patent Application Publication
(10) Pub. No.: US 2007/0211419 A1
(43) Pub. Date: Sep. 13, 2007

(54) PORTABLE NOTEBOOK COMPUTER

(75) Inventors: HSUAN-CHEN CHEN, Tu-Cheng (TW); LIN-YUN HONG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,990

(22) Filed: Dec. 22, 2006

(30) Foreign Application Priority Data
Mar. 10, 2006 (CN) 200610034357.7

(51) Int. Cl. G06F 1/16

(52) U.S. Cl. 361/683

(57) ABSTRACT

A portable notebook computer includes a base, and a display pivotably connected to the base. An I/O port is provided on a bottom surface of the base configured to connect the portable notebook computer to external electronic devices.

### BACKGROUND OF THE INVENTION

1. Field of the Invention

The present invention relates to portable notebook computers.

2. Description of Related Art

Personal computers can be classified into desktop computers, portable notebook computers, and etc. The desktop computers are easy to upgrade but inconvenient in carrying from place to place. Portable notebook computers however, are thin and lightweight. Therefore, portable notebook computers are very popular since they provide considerable convenience. The convenience and transportability of portable notebook computers has created a large and lucrative market for manufacturers of such machines. Generally, a portable notebook computer includes a plurality of I/O ports to extend its functions. The ports are usually set in edges of the portable notebook computer. To meet user's needs, portable notebook computers have become thinner and thinner. Adding more I/O ports to the edges of portable notebook computers has become more difficult because portable notebook computers are now so thin.

What is needed, therefore, is a portable notebook computer having more I/O ports provided therein.

### SUMMARY OF THE INVENTION

In one preferred embodiment, a portable notebook computer includes a base, and a display pivotably connected to the base. An I/O port is provided on a bottom surface of the base configured to connect the portable notebook computer to external electronic devices.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a portable notebook computer in accordance with a first preferred embodiment of the present invention; and

FIG. 2 is an assembled view of FIG. 1.

### DETAILED DESCRIPTION OF THE INVENTION

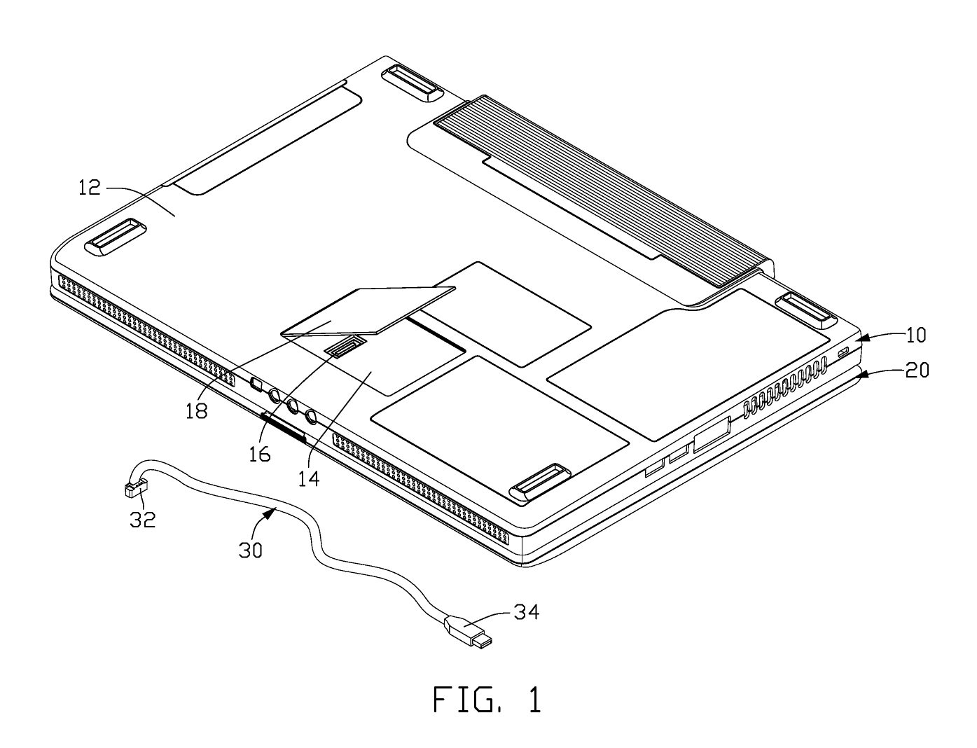

Referring to FIG. 1, in a preferred embodiment of the invention, a portable notebook computer includes a base 10, a display 20 pivotably connected to the base 10, and a cable 30. The base 10 includes a bottom surface 12 opposing the display 20 for being supported on a desk. A rectangular notch 14 is defined in the bottom surface 12 of the base 10. An I/O port 16 is set in the notch 14 and is electrically connected to a motherboard installed within the base 10. The I/O port may be an IEEE1394 port, a USB port or other type I/O port. A rectangular cover 18 is provided for covering the notch 14 to keep out dust.

The cable 30 includes a first plug 32 and a second plug 34 attached to ends thereof respectively. The first plug 32 is receivable in the I/O port 16.

In use, the cover 18 is detached from the base 10 to expose the USB port 16. The I/O port 16 receives the first plug 32 of the cable 30, then the second plug 34 of the cable 30 can be connected to an external device, such as another portable notebook computer.

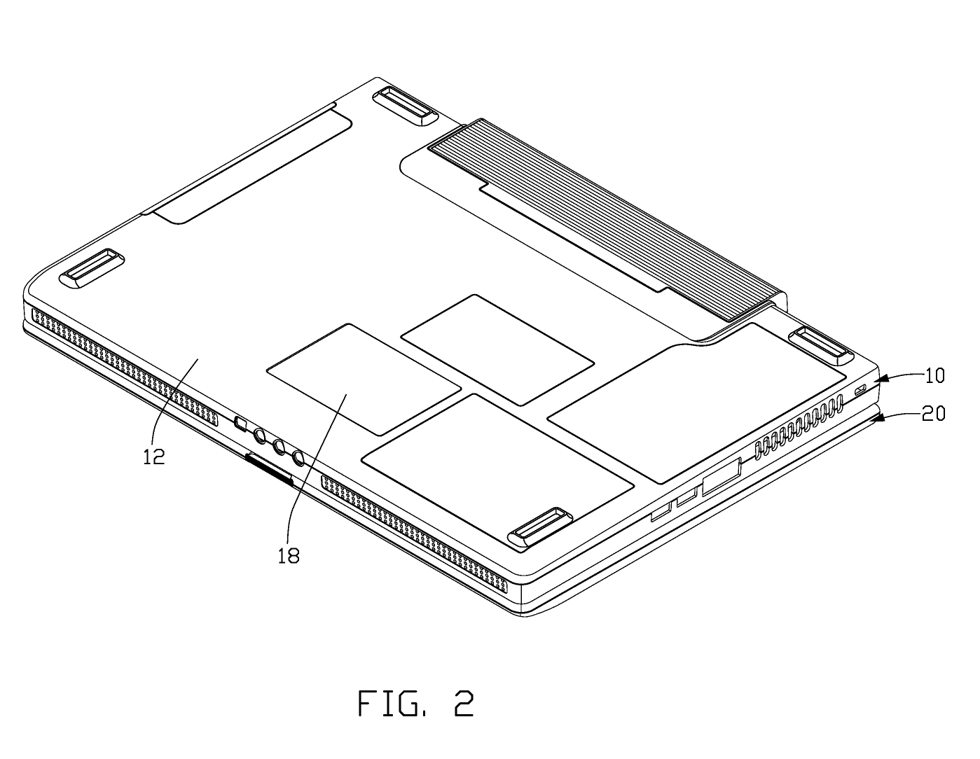

Referring to FIG. 2, when not in use, the cable 30 can be stored in the notch 14, and the notch 14 is covered by the cover 18.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A portable notebook computer comprising:
a base, an I/O port provided on a bottom surface of the base; and
a display pivotably connected to the base, wherein the bottom surface of the base is opposite to the display when the display is closed to cover the base.

2. The portable notebook computer as claimed in claim 1, wherein the bottom surface of the base defines a notch, the I/O port is set in the notch.

3. The portable notebook computer as claimed in claim 2, wherein a cover is provided for covering the notch.

4. The portable notebook computer as claimed in claim 3, wherein the notch and the cover are both rectangular.

5. The portable notebook computer as claimed in claim 2, wherein a cable is stored in the notch connectable with the I/O port for connecting the portable notebook computer to external electronic devices.

6. The portable notebook computer as claimed in claim 1, wherein the I/O port is a USB port.

7. The portable notebook computer as claimed in claim 1, wherein the I/O port is an IEEE 1394 port.

8. A portable notebook computer comprising:
a base comprising a bottom surface supportable on a desk;
at least one depressed portion sunk from one portion of the bottom surface;
at least one I/O port disposed in the at least one depressed portion for electrically connecting the computer to external electronic devices; and
a display connected to the base opposing the bottom surface when closed.

9. The portable notebook computer as claimed in claim 8, wherein a cover is provided to cover the I/O port when not in use.

10. The portable notebook computer as claimed in claim 9, wherein the cover is detachable from the base for exposing the at least one I/O port.

11. The portable notebook computer as claimed in claim 8, wherein the I/O port is a USB port.

12. The portable notebook computer as claimed in claim 8, wherein the I/O port is an IEEE 1394 port.

13. The portable notebook computer as claimed in claim 9, wherein a cable is stored in the depressed portion and covered by the cover, the cable being configured for connecting the portable notebook computer to external electronic devices.

14. The portable notebook computer as claimed in claim 13, wherein the cable comprises a first plug insertable into the at least one I/O port and a second plug configured to connect with the external electronic device, the first and second plug being arranged at opposite ends of the cable.
